(19) United States
(12) Patent Application Publication
(10) Pub. No.: US 2013/0338799 A1
(43) Pub. Date: Dec. 19, 2013

(54) AVAILABILITY MODEL GENERATION SUPPORT DEVICE, AVAILABILITY MODEL GENERATION SUPPORT METHOD, AND PROGRAM

(71) Applicant: Kumiko Tadano, Tokyo (JP)

(72) Inventor: Kumiko Tadano, Tokyo (JP)

(73) Assignee: NEC Corporation

(21) Appl. No.: 14/001,453

(22) PCT Filed: Feb. 21, 2012
(86) PCT No.: PCT/JP2012/054149

§ 371 Date: Aug. 23, 2013

(30) Foreign Application Priority Data
Mar. 4, 2011 (JP) 2011047423

(51) Int. Cl. G05B 15/02

(52) U.S. Cl. CPC G05B 15/02
USPC 700/12

(57) ABSTRACT

The present invention includes: a model module storage unit 102 for storing an availability model module which expresses, as an information model, a control for operating an information processing system and a state change of an object subjected to the control, and also storing rules of a connective relation between the availability model modules; and an availability model synthesizing unit 101 for synthesizing at least a part of the availability model module based on the rules of the connective relation, and generating an availability model for estimating an availability of the information processing system.

### BACKGROUND

The present invention relates to an availability model generation support device, an availability model generation support method, and a program of an information processing system.

Technology for estimating the availability of an information processing system is known. As an example of this type of technology, Patent Document 1 describes estimating the availability of an information processing system, during the operation of that information processing system, based on the configuration of the information processing system, and the failure rate and the recovery rate of the respective computers configuring the information processing system.

Moreover, Non-Patent Document 1 describes building a mathematical model corresponding to a specific system control, and estimating the availability based on that mathematical model.

Patent Document 1: U.S. Pat. No. 7,756,803

Non-Patent Document 1: V. Castelli et al., “Proactive management of software aging”, IBM Journal of Research and Development, IBM, March 2001, Volume No. 45, Issue No. 2, p. 311-332

### SUMMARY

Control such as setting changes and rebooting of the operating system that is performed for operating the information processing system is a major factor that considerably affects the availability of an information system. The technology described in Patent Document 1 does not give any consideration to the influence that the control has on the availability. Meanwhile, while Non-Patent Document 1 describes estimating the availability based on a mathematical model corresponding to a specific control, the mathematical model can only be applied to a specific control. Thus, in order to assess the influence that the various types of control used in system operation and management have on the availability, it is necessary to build individual availability models for each control, and there is a problem in that the productivity of model generation is low. Since the actual operation and management procedures include numerous types of control, to individually design availability models for all control is troublesome and inefficient.

Thus, an exemplary object of this invention is to provide an availability model generation support device, an availability model generation support method, and a program capable of efficiently assessing the influence that various types of system operation control will have on the availability.

The availability model generation support device according to the present invention includes: a model module storage unit for storing an availability model module which expresses, as an information model, a control for operating an information processing system and a state change of an object subjected to the control and also storing rules of a connective relation between the availability model modules; and an availability model synthesizing unit for synthesizing at least a part of the availability model module based on the rules of the connective relation, and generating an availability model for estimating an availability of the information processing system.

According to an exemplary aspect of the present invention, it is possible to efficiently assess the influence that various types of system operation control will have on the availability.

### DESCRIPTION OF DRAWINGS

FIG. 1 is a block diagram showing the configuration of the availability model generation support device according to Embodiment 1 of the present invention.

FIG. 2 is a flowchart of the operation of the availability model generation support device according to Embodiment 1 of the present invention.

FIG. 3 is a diagram explaining the stochastic reward net model that is used for expressing a model module according to Embodiment 1 of the present invention.

FIG. 4 is a diagram explaining the stochastic reward net model that is used for expressing a model module according to Embodiment 1 of the present invention.

FIG. 5 is a diagram showing an example of a synthesized availability model according to Embodiment 1 of the present invention.

FIG. 6 is a diagram showing an example of a synthesized availability model according to Embodiment 1 of the present invention.

FIG. 7 is a diagram showing an example of a synthesized availability model according to Embodiment 1 of the present invention.

FIG. 8 is a block diagram showing the configuration of the availability model generation support device according to Embodiment 2 of the present invention.

FIG. 9 is a flowchart of the operation of the availability model generation support device according to Embodiment 2 of the present invention.

FIG. 10 is a diagram showing an example of the model module that is selected by a user based on the selection options according to Embodiment 2 of the present invention.

FIG. 11 is a block diagram showing the configuration of the availability model generation support device according to Embodiment 3 of the present invention.

FIG. 12 is a flowchart of the operation of the availability model generation support device according to Embodiment 3 of the present invention.

### EXEMPLARY EMBODIMENT

### Embodiment 1

Exemplary embodiments of the present invention are now explained in detail with reference to the drawings.

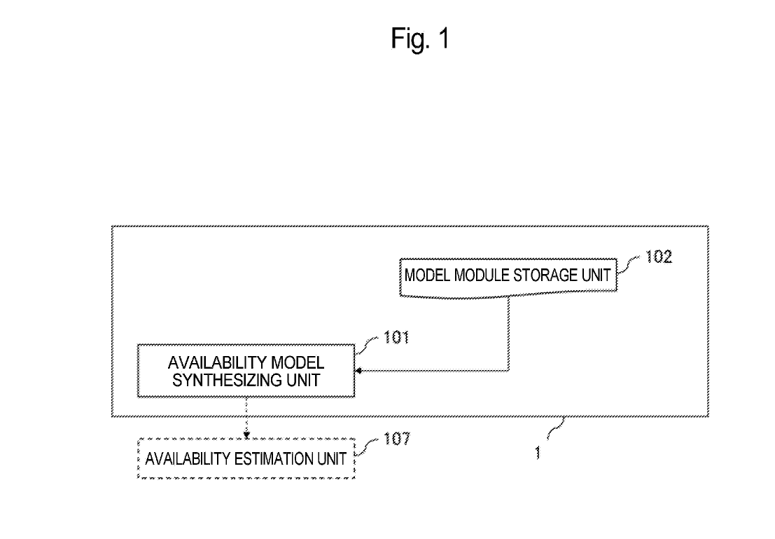

FIG. 1 is a block diagram showing the configuration of the availability model generation support device 1 according to Embodiment 1 of the present invention. The availability model generation support device 1 is a server device, a personal computer, or the like. The availability model generation support device 1 comprises a central processing unit (CPU) not shown, a storage device (memory and hard disk drive (HDD)), an input device (in this example, a keyboard), and an output device (in this example, a display). The availability model generation support device 1 is configured to realize the functions described later by the central processing unit executing the programs stored in the storage device.

In this embodiment, the information processing system is configured from at least one information processing device. Moreover, in this embodiment, availability is the operating ratio of the information processing system. The operating ratio is, for example, an instantaneous operating ratio, an average operating ratio, or the like. The instantaneous operating ratio is the probability that the information processing system is maintaining its function at a specific point in time. Moreover, the average operating ratio is the probability that the information processing system is maintaining its function during a predetermined period.

As shown in FIG. 1, the availability model generation support device 1 comprises an availability model synthesizing unit 101, a model module storage unit 102, and an availability estimation unit 107. The availability model synthesizing unit 101 and the availability estimation unit 107 correspond to modules of the functions that are realized by the CPU executing predetermined programs stored in the ROM or the like. The model module storage unit 102 is loaded from an external storage device.

The availability model synthesizing unit 101 synthesizes at least a part of the availability model modules stored in the model module storage unit 102 according to the rules of the connective relation, and generates an availability model for estimating the availability of the information processing system.

In this embodiment, the availability model is a model that represents the relation of values of a plurality of parameters representing the likelihood of a state change in the respective model modules used for synthesizing the availability model, and the availability of the information processing system.

Moreover, in this embodiment, the parameters are, for example, an average execution time as an average of the time required for executing certain control, success probability as the probability that the execution of certain control will succeed, and probability that the control target will be subject to a failure when the execution of certain control ends in a failure.

Moreover, the availability model synthesizing unit 101 acquires the values of the parameters of the respective model modules. The availability model synthesizing unit 101 acquires the values of the parameters of the respective model modules stored in the model module storage unit 102. Note that the availability model synthesizing unit 101 may also be configured to acquire the values by receiving the values of the respective parameters that were input by the user.

The model module storage unit 102 stores the availability model modules, and the rules of connective relation of the model modules. An availability model module is a componentization of the control that is performed for operating the information processing system and the state change of the control-target system component (for example, a guest OS). In this embodiment, a model module is represented as a model based on probability distribution (for example, model based on stochastic reward net). Moreover, in this embodiment, the rules of the connective relation of the model modules define which model module can be connected with which model module upon synthesizing the model modules to generate an availability model.

The availability estimation unit 107 acquires the availability models and the parameter values from the availability model synthesizing unit 101. Note that, in substitute for the availability model synthesizing unit 101, the availability estimation unit 107 may also be configured to acquire the values of the parameters of the respective model modules stored in the model module storage unit 102. Moreover, the availability estimation unit 107 may acquire the values of the respective parameters that were input by the user in substitute for acquiring such parameter values from the availability model synthesizing unit 101. The availability estimation unit 107 estimates the availability of the information processing system based on the acquired values of the respective parameters and the availability model generated by the availability model synthesizing unit 101.

The operation of the availability model generation support device 1 is now explained.

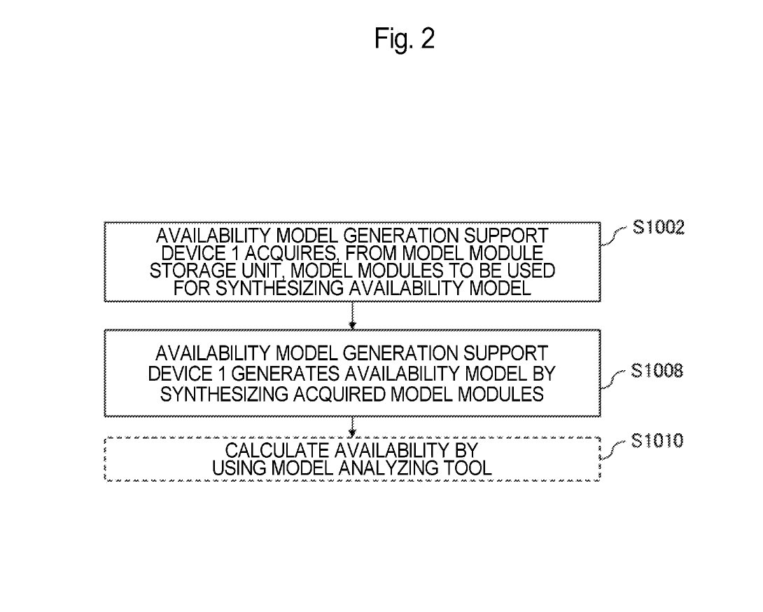

FIG. 2 is a flowchart of the operation of the availability model generation support device 1.

Foremost, the availability model generation support device 1 acquires, from the model module storage unit 102, the model modules to be used for synthesizing the availability model (step S1002). Here, the user selects the model modules to be used for synthesizing the availability model among the model modules stored in the model module storage unit 102 based on the features of the information processing system to be assessed. As the model modules, used may be those in which the values of the parameters incidental to the model modules have been pre-set. Otherwise, the user may separately input the parameter values.

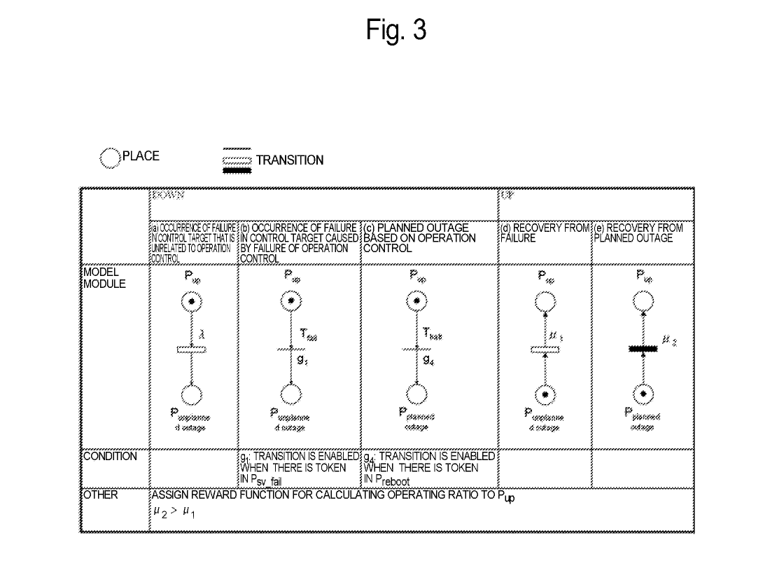

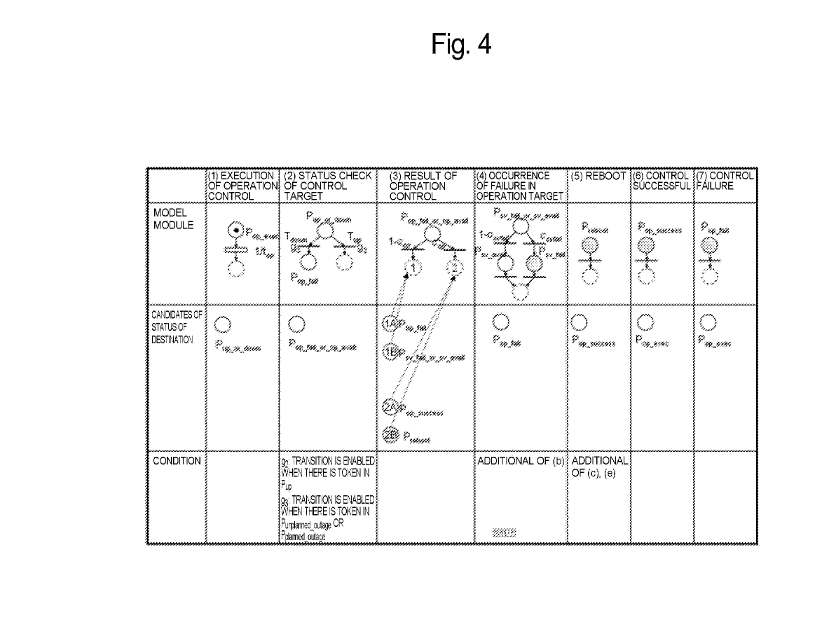

The stochastic reward net model that is used for representing the model modules in this embodiment is now briefly explained with reference to FIG. 3 and FIG. 4. The stochastic reward net model used in this embodiment is configured from place, transition, arc, guard function, and reward function. Here, a place (white circle) represents the states that the information system could become. Here, the place with a token (black circle) is deemed the current state. The place with the same name existing in a plurality of model modules represents the same state. Here, a transition corresponds to an event that will cause the change of state (movement of token). As the transition, there are, for example, a transition to which the change probability is assigned (white rectangle), a transition that will cause a state change at regular time intervals (black rectangle), and a transition that will immediately cause a state change (single line), and there are cases where the guard function described later may be assigned. An arc connects the transition and the place and represents the direction of state change. A guard function is assigned to the transition, and disables a state change according to conditions as described below.

g₁ in (b) of FIG. 3 enables the state change of T_{fail} when the token is in place Pₛᵥ_{_{—}}_{fail} in (4) of FIG. 4.

g₂ in (2) of FIG. 4 enables the state change of Tᵤₚ when the token is in place Pᵤₚ of FIG. 3.

g₃ in (2) of FIG. 4 enables the state change of T_{down} when the token is in place P_{unplanned}_{_{—}}_{outage} or P_{planned}_{_{—}}_{outage} of FIG. 3.

g₄ in (c) of FIG. 3 enables the state change of Tₕₐₗₜ when the token is in place P_{reboot} in (5) of FIG. 4.

The reward function is a function in which the output changes according to the number of tokens in the place. Here, considered is a case where one token in Pᵤₚ is defined as “in operation”. Here, when a reward function of outputting 1 when there is one token in Pᵤₚ and outputting 0 when there is no token is to be defined, the operating ratio can be obtained by calculating the time average value of the number of tokens in Pᵤₚ.

Among the examples of the model modules shown in FIG. 3 and FIG. 4, (a) to (e) of FIG. 3 are the model modules representing the state change of the control-target system component (for example, a guest OS), and (1) to (5) of FIG. 4 are the model modules representing the system operation control (for example, setting change).

The model modules of the control-target system component of FIG. 3 are now explained. Note that, with respect to the place, Pᵤₚ represents a state where the control target is in operation, P_{unplanned}_{_{—}}_{outage} represents a state where the control target was unintentionally stopped, and P_{planned}_{_{—}}_{outage} represents a state during planned outage. Let it be assumed that the initial location of the token is Pᵤₚ. With respect to the parameters, λ represents the failure rate of the control target (probably of crashing due to the load or resource consumption irrespective of the operation control), μ₁ represents the recovery rate from a failure upon the occurrence of a system failure, and μ₂ represents the recovery rate from a planned outage during normal operation.

Normally, upon the occurrence of a failure, time is required for diagnosing the cause of and taking measures for the failure, and, since it is considered that more time is required in comparison to recovery from a planned outage, μ₁<μ₂. In other words, the state change of (d) is less likely to occur than the state change of (e).

The respective model modules (a) to (e) of the control-target system component are now explained.

(a) represents the occurrence of a failure that is unrelated to the operation control (spontaneous state change)

(b) represents the occurrence of a failure in the control target that is caused by the failure of the operation control

(c) represents the planned outage based on the operation control

(d) represents the recovery from a failure

(e) represents the recovery from a planned outage

The model modules representing the system operation control of FIG. 4 are now explained. Note that, with respect to the place, Pₒₚ_{_{—}}_{exec} represents a state that the control is being executed, Pₒₚ_{_{—}}_{fail} represents a state that the control has failed, Pₒₚ_{_{—}}_{success} represents a state that the control has succeeded, Pₛᵥ_{_{—}}_{fail} represents a state that the failure of the control has caused a failure in the control target, Pₛᵥ_{_{—}}ₐᵥₐᵢₗ represents a state where the control has failed but did not affect the control target, and P_{reboot} represents a state of rebooting the control target. Let it be assumed that the initial location of the token is Pₒₚ_{_{—}}_{exec}. With respect to the parameters, tₒₚ represents the average effective time of the control, cₒₚ represents the success probability of the control, and c_{svfail} represents the probability that the failure of the control will affect the availability of the control target.

The respective model modules (1) to (5) of the system operation control are now explained.

(1) represents the execution of the operation control

(2) represents the status check of the control target

(3) represents the result of the operation control

(4) represents the occurrence of a failure in the control target, and the model module (b) is required as a condition for using this model module

(5) represents the reboot of the control target, and the model modules (c), (e) are required as a condition for using this model module

(6) represents the success of the control

(7) represents the failure of the control

In FIG. 4, regarding the respective model modules, candidates of the place (state) of the destination are indicated as the rules for synthesizing the model modules. Specifically, for example, since the candidate of the place of the destination of the model module (1) is Pᵤₚ_{_{—}}ₒᵣ_{_{—}}_{down}, this shows that the model module (1) can be connected to the model module (2) which starts from that place.

The availability model generation support device 1 generates an availability model by synthesizing the acquired model modules based on the conditions of the acquired model modules and the candidate of the state of the destination of the model modules shown in FIG. 4 (step S1008 of FIG. 2). Specifically, the following two synthesis are performed in relation to the acquired model modules. First, a control-target system component model is generated by synthesizing the model modules (integrating the same places) of the control-target system component. Second, a system operation control model is generated by synthesizing the model modules of the system operation control. Here, as shown in (3) of FIG. 4, when there are a plurality of candidates of the state of the destination of the model module, synthesis is performed so that all of the acquired model modules of the system operation control are connected.

Note that, here, interaction between the control-target system component model and the system operation control model is defined by the guard function. The combination of the control-target system component model and the system operation control model becomes the availability model of this embodiment.

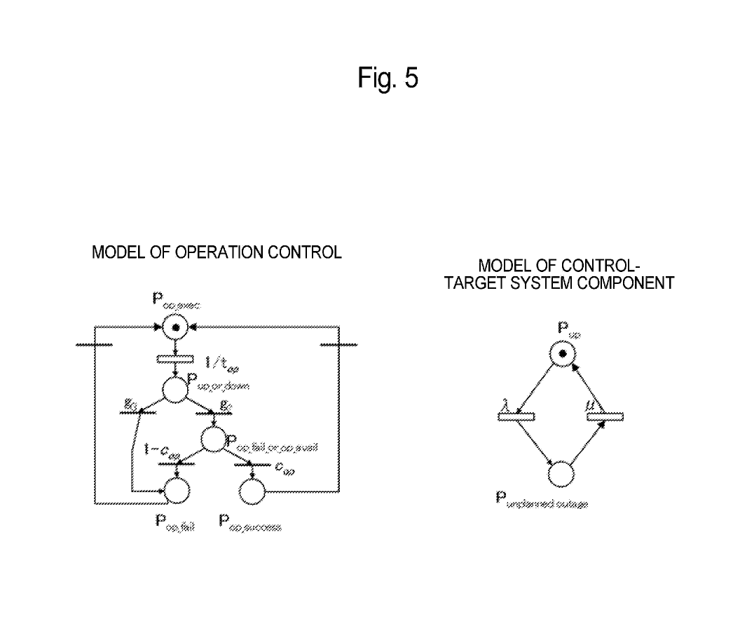

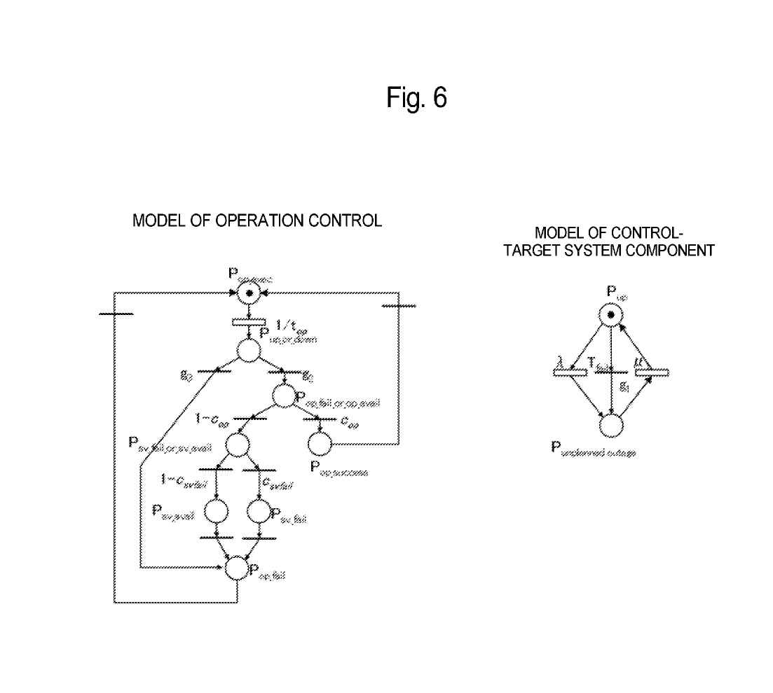

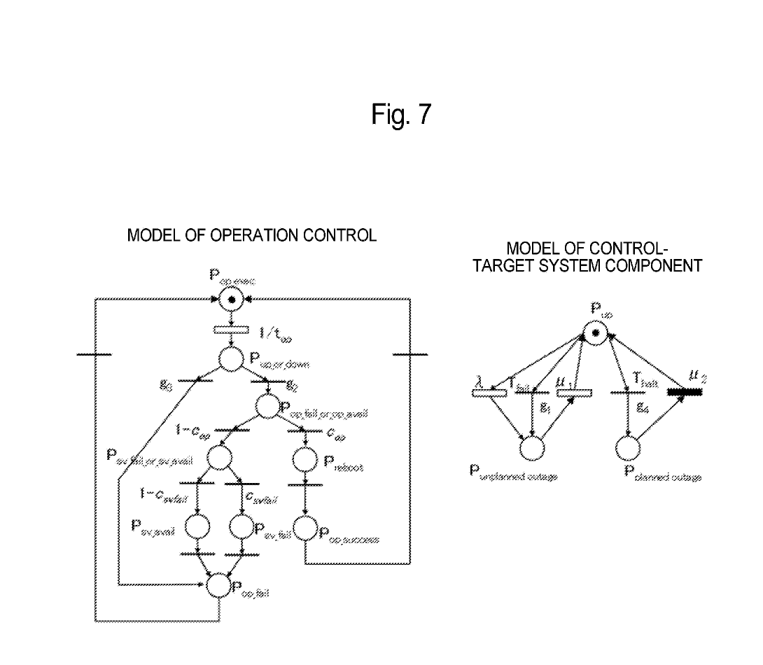

Examples of the synthesized availability model are shown in FIG. 5, FIG. 6, and FIG. 7.

The availability model shown in FIG. 5 is the availability model of the information processing system when control, such as state monitoring, that does not change the state of the control target is performed, and is the availability model in the case of selecting the model modules (a), (d), (1), (2), (3), (6), (7).

The availability model shown in FIG. 6 is the availability model of the information processing system in a case where failure in control, such as the setting change of the operating system, may cause a failure in the control target, and is the availability model in the case of selecting the model modules (a), (b), (d), (1), (2), (3), (4), (6), (7).

The availability model shown in FIG. 7 is the availability model of the information processing system in a case where, such as with a reboot, the control itself includes a planned outage of the control target, and is the availability model in the case of selecting the model modules (a), (b), (c), (d), (e), (1), (2), (3), (4), (5), (6), (7).

Note that when model modules that do not satisfy the conditions are synthesized (for instance, when there is a shortage in the necessary model modules), a warning may be displayed to the user. Here, it is also possible to present which condition has not been satisfied. Moreover, certain defective model modules may be automatically compensated based on the conditions of use of the model modules.

The availability model generation support device 1 estimates (calculates) the availability of the information system based on the synthesized availability model using a model analyzing tool (step S1010 of FIG. 2). In this embodiment, the availability model generating apparatus 1 estimates the availability using SHARPE (Symbolic Hierarchical Automated Reliability and Performance Evaluator), SPNP (Stochastic PetriNet Package) or other known technology.

In this embodiment, the availability model generation support device 1 assumes that the state of the information processing system is an operating state when the token is in place Pᵤₚ. In the foregoing case, the availability model generation support device 1 can assign the reward function for calculating the availability to place Pᵤₚ, and thereby cause the availability estimation unit 107 to calculate the availability.

For example, the availability model generation support device 1 assigns in advance to place Pᵤₚ of the model modules, as the reward function, the function of outputting “1” when the token is in place Pᵤₚ and outputting “0” when the token is in a place other than place Pᵤₚ. In the foregoing case, the availability estimation unit 107 calculates, as the average operating ratio, the time average value of the output values of the reward function.

Subsequently, the availability estimation unit 107 acquires the availability models and the parameter values from the availability model synthesizing unit 101. The availability estimation unit 107 estimates the availability of the information processing system based on the acquired respective parameter values and the availability model generated by the availability model synthesizing unit 101. The availability estimation unit 107 outputs the value of the estimated availability. In this embodiment, the value of the availability is displayed on a display.

As described above, according to this embodiment, by synthesizing at least a part of the model modules representing the state change related to the availability, it is possible to generate an availability model for estimating the availability of the information processing system in which various types of control are executed in the system operation and management. It is thereby possible to easily improve the productivity of the generation of the availability model of the information processing system.

### Embodiment 2

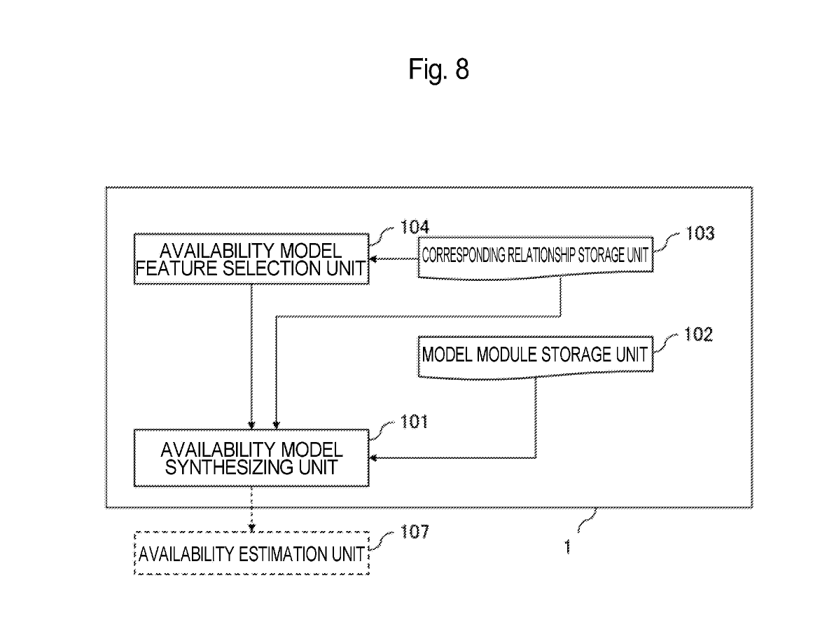

FIG. 8 is a block diagram showing the configuration of the availability model generation support device 1 according to Embodiment 2 of the present invention. The same reference numerals as those used in FIG. 1 represent an equivalent configuration. In Embodiment 2, rather than the user directly selecting the model module to be used for synthesizing the availability models from the model module storage unit 102 as in Embodiment 1, features of the availability model are presented using natural language or the like and selected by the user for synthesizing the availability models. The foregoing difference is mainly explained below.

As shown in FIG. 8, the availability model generation support device 1 according to Embodiment 2 comprises a corresponding relationship storage unit 103 and an availability model feature selection unit 104 in addition to the functions of the availability model generation support device 1 according to Embodiment 1.

The availability model feature selection unit 104 presents, to the user, options of the features related to the availability model. For example, options and check boxes for inputting the selected option may be displayed on a Web browser, and cause the user to select the option(s). The user inputs the selected option based on the characteristics of the information processing system to be assessed. Here, the availability model feature selection unit 104 may also urge the user to input the value (for instance, λ) of a related parameter in addition to the selection option of the features. The availability model feature selection unit 104 receives the selection option of the features.

The availability model synthesizing unit 101 acquires, from the model module storage unit 102, the model module corresponding to the selection option received by the availability model feature selection unit 104 based on the corresponding relationship of the selected option and the model module stored in the corresponding relationship storage unit 103.

The availability model synthesizing unit 101 generates an availability model by synthesizing the acquired model modules as with the availability model synthesizing unit 101 according to Embodiment 1.

The corresponding relationship storage unit 103 stores the selection option received by the availability model feature selection unit 104, and the corresponding relationship of the model module corresponding to that selected option. For example, the availability model feature selection unit 104 may present a question described in a natural language as shown below, and the corresponding relationship storage unit 103 may receive, as the selected option, YES/NO in response to the respective questions.

(I) When the operation control fails, is there a possibility that the server will be subject to a failure? (Corresponding control example: network setting change)

(II) Will the operation control reboot the control target? (Corresponding control example: rejuvenation control for preventing failures)

In the foregoing case, there are the following four types of selected options.

(A) When all is NO

(B) When only (I) is YES

(C) When only (II) is YES

(D) When (I) and (II) are YES

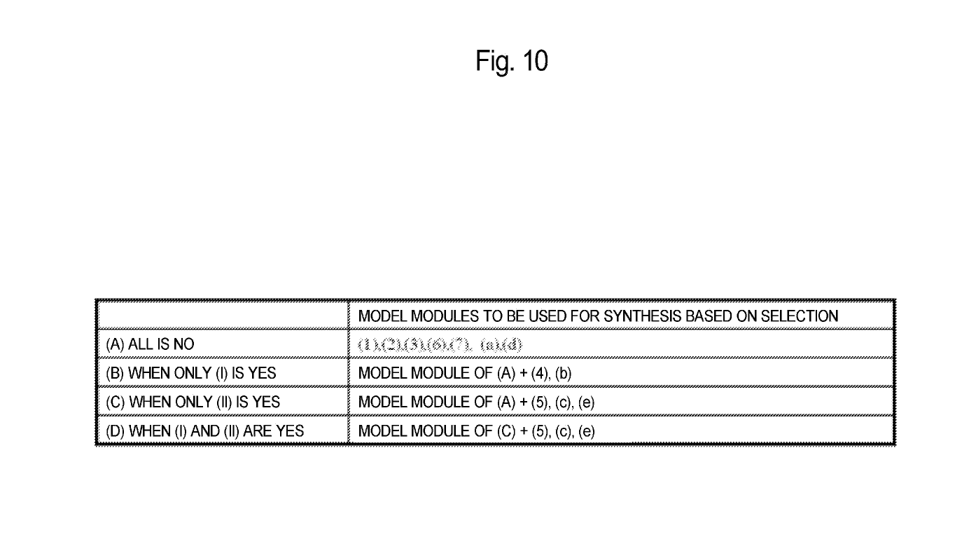

The model modules corresponding to the selected options in the foregoing case are shown in FIG. 10. As described above, features of the model are presented in the natural language, and the corresponding relationship of the model module corresponding to the user's selected option is stored in the corresponding relationship storage unit 103 in advance.

Moreover, the corresponding relationship storage unit 103 may also store the corresponding relationship between the type of control and the model modules rather than a Q&A format. In the foregoing case, the availability model feature selection unit 104 will present a specific example of the control described in a natural language as shown below, and receive the selected option by causing the user to select the control.

(α) Status monitoring

(62 ) Change of important configuration settings (for example, change of the environmental variable of the operating system)

(γ) Reboot after change of important configuration settings (for example, reboot for reflecting the settings after the network setting change)

With respect to the corresponding relationship between the control and the model module in the foregoing case, the model module corresponding to (α) is the same as (A), the model module corresponding to (β) is the same as (B), and the model module corresponding to (γ) is the same as (D).

The availability estimation unit 107 estimates (calculates) the availability based on the availability model generated by the availability model synthesizing unit 101 as with Embodiment 1.

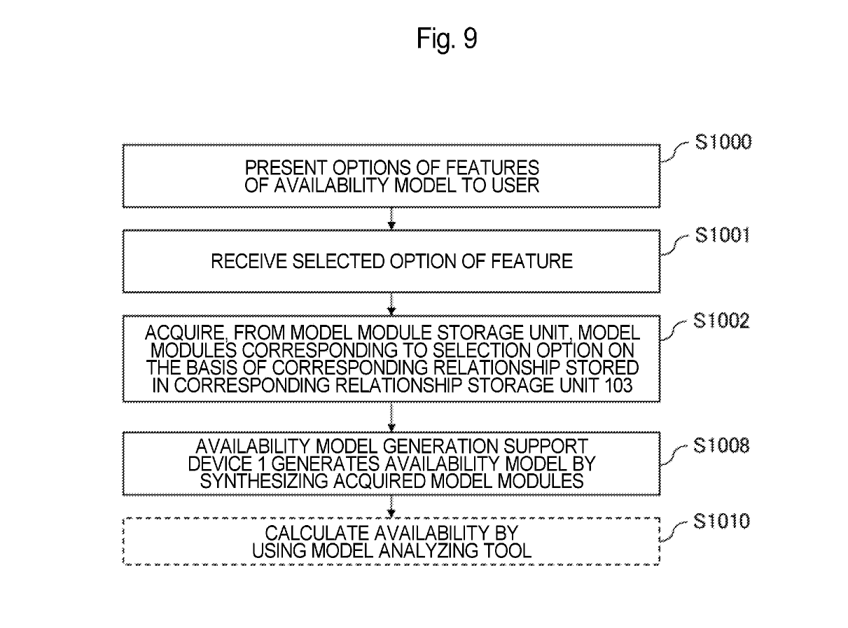

The operation of the availability model generation support device 1 according to Embodiment 2 is now explained with reference to FIG. 9.

Foremost, the availability model generation support device 1 presents, to the user, the options of the features related to the availability model (step S1000).

Subsequently, the availability model generation support device 1 receives the selection option of the features input by the user (step S1001).

Subsequently, the availability model generation support device 1 acquires, from the model module storage unit 102, the model modules corresponding to the selection option based on the corresponding relationship stored in the corresponding relationship storage unit 103 (step S1002).

Subsequently, the availability model generation support device 1 generates the availability model by synthesizing the acquired model modules (step S1008).

Subsequently, the availability model generation support device 1 estimates (calculates) the availability by analyzing the generated availability model using a model analyzing tool of existing technology (step S1010).

As described above, according to this embodiment, in addition to being able to obtain the same effects as Embodiment 1, by using the options based on a natural language, the user can calculate the availability of the system to be assessed by building an availability model even without knowledge of mathematical modeling. Accordingly, it is possible to reduce the training costs of the user.

### Embodiment 3

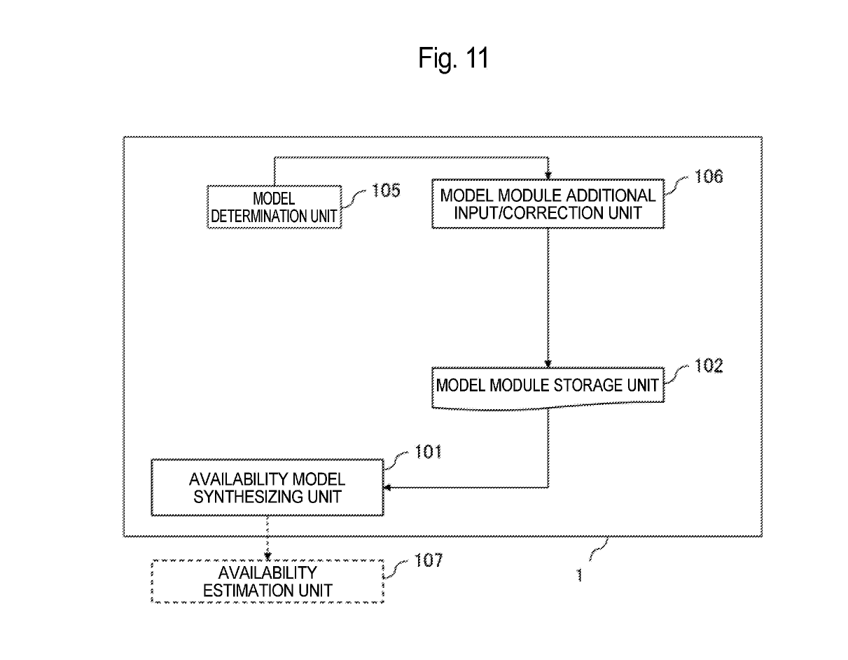

FIG. 11 is a block diagram showing the configuration of the availability model generation support device 1 according to Embodiment 3 of the present invention. The same reference numerals as those used in FIG. 1 represent an equivalent configuration. In Embodiment 3, when there is any shortage in the model modules, model modules can be added or corrected. The foregoing difference is mainly explained below.

As shown in FIG. 11, the availability model generation support device 1 according to Embodiment 3 comprises a model determination unit 105 and a model module additional input/correction unit 106 in addition to the functions of the availability model generation support device 1 according to Embodiment 1.

The model determination unit 105 determines whether there is any shortage in the model modules stored in the model module storage unit 102. The determination is made based on the user's input. When there is shortage in the model modules, the model module additional input/correction unit 106 urges the user to input a model module.

The model module additional input/correction unit 106 receives the input of addition/correction of the model module from the user, and adds a model module to the model module storage unit 102 or corrects an existing model module.

The availability model synthesizing unit 101, as with Embodiment 1, synthesizes at least a part of the availability model modules stored in the model module storage unit 102 according to the rules of the connective relation, and generates an availability model for estimating the availability of the information system.

The availability estimation unit 107, as with Embodiment 1, estimates (calculates) the availability of the information system based on the availability model generated by the availability model synthesizing unit 101.

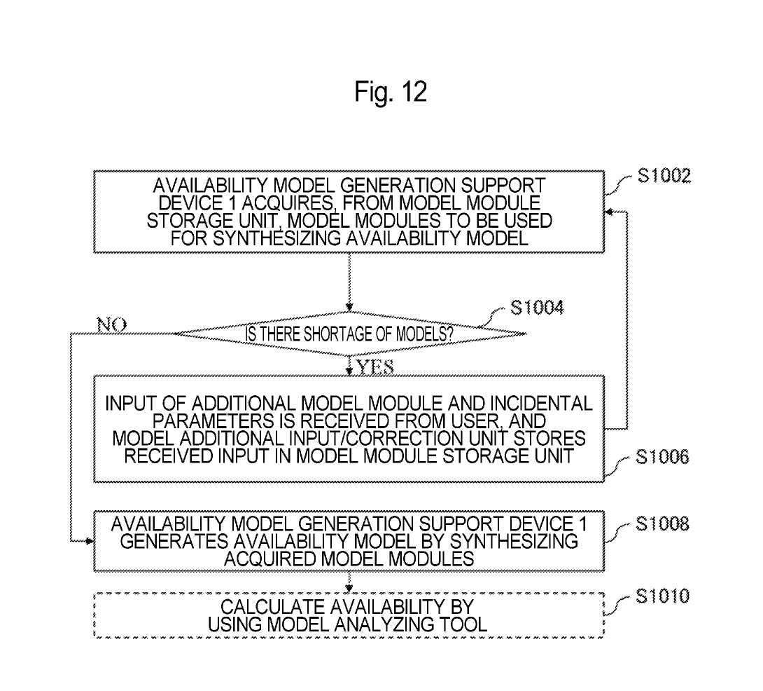

The operation of the availability model generation support device 1 according to Embodiment 3 is now explained with reference to FIG. 12.

Foremost, the availability model generation support device 1 acquires, from the model module storage unit 102, the model modules to be used for synthesizing an availability model (step S1002).

Subsequently, the availability model generation support device 1 determines whether there is any shortage in the model modules stored in the model module storage unit 102 (step S1004), and proceeds to step S1006 if there is any shortage (YES), and proceeds to step S1008 if there is no shortage (NO).

In step S1006, input of the model module to be added and incidental parameters is received from the user, and the model additional input/correction unit 106 stores the received input in the model module storage unit 102. After the addition/correction of the model module is completed, the availability model generation support device 1 returns to step S1002.

Subsequently, the availability model generation support device 1 causes the availability model synthesizing unit 101 to generate an availability model by synthesizing the acquired model modules (step S1008).

Subsequently, the availability model generation support device 1 analyzes the generated availability model using a model analyzing tool of existing technology, and estimates (calculates) the availability (step S1010). Note that step S1004 may be executed before step S1002.

According to this embodiment described above, in addition to being able to obtain the same effects as Embodiment 1, by enabling the addition/correction of the model module, it becomes possible to assess the influence that the operation control in which the contents thereof were changed or new operation control that was previously unavailable has on the availability, and the flexibility of availability modeling can be improved.

Note that the present invention is not limited to Embodiments 1 to 3 described above. The configuration and operation of the present invention can be variously modified by those skilled in the art within the scope of the present invention.

This application relates to and claims priority from Japanese Patent Application No. 2011-474237, filed on Mar. 4, 2011, the entire disclosure of which is incorporated herein by reference.

The present invention was explained above with reference to the embodiments, but the present invention is not limited to the foregoing embodiments. The configuration and details of the present invention can be variously modified by those skilled in the art within the scope of the present invention.

In each of the foregoing embodiments, while the respective functions of the availability model generating apparatus 1 were realized by the CPU executing programs (software), the respective functions may also be realized via hardware such as circuits. Moreover, while the programs are stored in a storage device in each of the foregoing embodiments, the programs may also be stored in a computer-readable storage medium. The recording medium is a portable medium such as a flexible disk, an optical disk, a magneto-optical disk, or a semiconductor memory. Moreover, as a modified example of the present invention, a configuration which combines each of the foregoing embodiments may also be adopted.

A part or all of the foregoing embodiments can also be described as indicated in the following Notes, but the present invention is not limited thereto.

(Note 1) An availability model generation support device, comprising:

a model module storage unit for storing an availability model module which expresses, as an information model, a control for operating an information processing system and a state change of an object subjected to the control, and also storing rules of a connective relation between the availability model modules; and

an availability model synthesizing unit for synthesizing at least a part of the availability model module based on the rules of the connective relation, and generating an availability model for estimating an availability of the information processing system.

(Note 2) The availability model generation support device according to Note 1 above, further comprising:

an availability model feature selection unit for presenting, to a user, options related to features of the availability model; and

a corresponding relationship storage unit for storing a selection option that is selected among the options, and a corresponding relationship of a model module corresponding to the selected option.

(Note 3) The availability model generation support device according to Note 1 or Note 2 above, further comprising:

a model determination unit for determining whether there is any shortage of model modules stored in the model module storage unit; and

a model module additional input/correction unit for receiving an addition or corrective input of a model module from a user, and storing the model module added to the model module storage unit upon receiving an addition of a model module, and moreover correcting the model module stored the model module storage unit upon receiving a corrective input of a model module.

(Note 4) An availability model generation support method, comprising the steps of:

acquiring, from a model module storage unit storing an availability model module which expresses, as an information model, a control for operating an information processing system and a state change of an object subjected to the control, and also storing rules of a connective relation between the availability model modules, at least a part of the availability model module; and

synthesizing the acquired availability model module based on the rules of the connective relation, and generating an availability model for estimating an availability of the information processing system.

(Note 5) A program for causing a computer to function as:

a model module storage unit for storing an availability model module which expresses, as an information model, a control for operating an information processing system and a state change of an object subjected to the control, and rules of a connective relation between the availability model modules; and

an availability model synthesizing unit for synthesizing at least a part of the availability model module based on the rules of the connective relation, and generating an availability model for estimating an availability of the information processing system.

The present invention is suitable for efficiently assessing the influence that various types of system operation control will have on the availability.

1 availability model generation support device

101 availability model synthesizing unit

102 model module storage unit

103 corresponding relationship storage unit

104 availability model feature selection unit

105 model determination unit

106 model module additional input/correction unit

107 availability estimation unit

1. An availability model generation support device, comprising:
a model module storage unit for storing an availability model module which expresses, as an information model, a control for operating an information processing system and a state change of an object subjected to the control, and also storing rules of a connective relation between the availability model modules; and
an availability model synthesizing unit for synthesizing at least a part of the availability model module based on the rules of the connective relation, and generating an availability model for estimating an availability of the information processing system.

2. The availability model generation support device according to claim 1, further comprising:
an availability model feature selection unit for presenting, to a user, options related to features of the availability model; and
a corresponding relationship storage unit for storing a selection option that is selected among the options, and a corresponding relationship of a model module corresponding to the selected option.

3. The availability model generation support device according to claim 1, further comprising:
a model determination unit for determining whether there is any shortage of model modules stored in the model module storage unit; and
a model module additional input/correction unit for receiving an addition or corrective input of a model module from a user, and storing the model module added to the model module storage unit upon receiving an addition of a model module, and moreover correcting the model module stored the model module storage unit upon receiving a corrective input of a model module.

4. An availability model generation support method, comp sin the steps of:
acquiring, from a model module storage unit storing an availability model module which expresses, as an information model, a control for operating an information processing system and a state change of an object subjected to the control, and also storing rules of a connective relation between the availability model modules, at least a part of the availability model module; and
synthesizing the acquired availability model module based on the rules of the connective relation, and generating an availability model for estimating an availability of the information processing system.

5. A program for causing a computer to function as:
a model module storage unit for storing an availability model module which expresses, as an information model, a control for operating an information processing system and a state change of an object subjected to the control, and rules of a connective relation of the availability model modules; and
an availability model synthesizing unit for synthesizing at least a part of the availability model module based on the rules of the connective relation, and generating an availability model for estimating an availability of the information processing system.
